(19) United States
(12) Patent Application Publication
(10) Pub. No.: US 2026/0049812 A1
(43) Pub. Date: Feb. 19, 2026

(54) ONE OR MORE REFERENCE OPTICAL ELEMENTS OF A METROLOGY SYSTEM

(71) Applicant: Lumentum Operations LLC, San Jose, CA (US)

(72) Inventors: Driss TOUAHRI, Ottawa (CA); Daniel John WAHL, Ottawa (CA); Alan HNATIW, Ottawa (CA)

(21) Appl. No.: 18/920,009

(22) Filed: Oct. 18, 2024

Related U.S. Application Data
(60) Provisional application No. 63/684,706, filed on Aug. 19, 2024.

(51) Int. Cl. G01B 11/14

(52) U.S. Cl. CPC G01B 11/14

(57) ABSTRACT

A metrology system includes a window and one or more reference optical elements. The window is configured to permit transmission, via a clear aperture of the window, of a measurement light beam from an internal environment of the metrology system to an external environment. The one or more reference optical elements are disposed on the window. Each reference optical element, of the one or more reference optical elements, is configured to return, to the internal environment of the metrology system, a portion of a calibration light beam that originates from the internal environment of the metrology system and impinges on the reference optical element.

### CROSS-REFERENCE TO RELATED APPLICATION

This Patent Application claims priority to U.S. patent application Ser. No. 63/684,706, filed on Aug. 19, 2024, and entitled “ONE OR MORE REFERENCE FEATURES TO FACILITATE CALIBRATION OF AN OPTICAL METROLOGY SYSTEM.” The disclosure of the prior Application is considered part of and is incorporated by reference into this Patent Application.

### TECHNICAL FIELD

The present disclosure relates generally to a metrology system and to one or more reference optical elements of the metrology system.

### BACKGROUND

An optical metrology system utilizes light to measure various physical properties, such as shape, size, or texture, of an object or features of an object.

### SUMMARY

In some implementations, a metrology system includes a window configured to permit transmission, via a clear aperture of the window, of a measurement light beam from an internal environment of the metrology system to an external environment; and one or more reference optical elements that are disposed on the window, wherein each reference optical element, of the one or more reference optical elements, is configured to return, to the internal environment of the metrology system, a portion of a calibration light beam that originates from the internal environment of the metrology system and impinges on the reference optical element.

In some implementations, a metrology system includes a window configured to permit transmission, via a clear aperture of the window, of a measurement light beam; and one or more reference optical elements that are disposed on a region of a surface of the window that is not associated with the clear aperture of the window, wherein each reference optical element, of the one or more reference optical elements, is configured to return a portion of a calibration light beam that impinges on the reference optical element.

In some implementations, a metrology system includes one or more reference optical elements that are disposed on a window; and an optical sensor that is configured to: receive, from each reference optical element, of the one or more reference optical elements, a portion of a particular calibration light beam that impinges on the reference optical element.

### BRIEF DESCRIPTION OF THE DRAWINGS

FIGS. 1A-1C are diagrams of an example implementation associated with one or more reference optical elements of a metrology system.

FIGS. 2A-2D are diagrams of an example implementation associated with one or more reference optical elements of a metrology system.

FIG. 3 is a diagram of an example environment in which systems and/or methods described herein may be implemented.

FIG. 4 is a diagram of example components of a device associated with one or more reference optical elements of a metrology system.

### DETAILED DESCRIPTION

The following detailed description of example implementations refers to the accompanying drawings. The same reference numbers in different drawings may identify the same or similar elements.

An optical metrology system can be used to measure a three-dimensional (3D) geometry (e.g., a 3D shape, texture, or other physical characteristic) of an object by utilizing optical analysis techniques, such as techniques associated with structured light, direct time of flight, indirect time of flight, and frequency chirping. For example, when one or more scanning-type optical sensors are used, an optical beam (e.g., a laser beam) can be swept across the object to perform distance measurements and therefore generate a profile or a two-dimensional (2D) mapping of the object. A performance (e.g., a measurement performance) of the one or more scanning-type optical sensors relies on a calibration of the one or more scanning-type optical sensors to convert distance and angle measurements into an accurate representation (e.g., an accurate profile or an accurate 2D mapping) of the object. Furthermore, a stability of the calibration is necessary to maintain an accuracy of the one or more scanning-type optical sensors, especially when multiple scanning-type optical sensors are involved in measuring the object.

In some optical metrology systems (e.g., a scanning-type optical metrology system that utilize an optical sensor and at least one of a laser, one or more 2D beam scanners, or a beam focusing mechanism), an optical sensor determines an optical path length (e.g., of an optical beam, such as a laser beam) to an object (or to a point of the object) and an optical launch angle (e.g., of the optical beam) to the object (or to the point of the object) to generate a reference position (or coordinate) of the object (or of the point of the object). The determined optical path length needs to compensate for any effects introduced by the optical metrology system itself, such as by components of the optical metrology system, including optics, one or more 2D beam scanners, a beam focusing mechanism, and an exit window of the optical metrology system. In particular, the exit window often introduces distortions and other aberrations. Moreover, the optical launch angle must be determined so as to compensate for any distortions, aberrations, temperature changes, or ageing associated with the optical metrology system. Often, mirrors on rotational motors can be equipped with mechanical position sensors to indirectly determine an optical angle to an object based on an expected behavior of an optical beam through the optical metrology system. However, such mechanical position sensors are unable to compensate for changes in the position of an optical beam due to ageing, mechanical stress, temperature changes, or other issues associated with the optical metrology system.

Some implementations described herein include a metrology system (e.g., an optical metrology system, such as a scanning-type optical metrology system). The metrology system includes a window (e.g., at an end of the metrology system) that permits transmission of a light beam from an internal environment of the metrology system to an external environment. For example, the window permits transmission of a measurement light beam (e.g., that is emitted by at least one light source of the metrology system, to facilitate measurement of a measurement target), such as via a clear aperture of the window.

The metrology system includes one or more reference optical elements that are disposed on the window (e.g., on a surface of the window). For example, each reference optical element may be disposed on a region of the surface of the window that is not associated with the clear aperture of the window (e.g., on a perimeter region of the surface of the window, such as when the clear aperture is associated with a central region of the surface of the window). Each reference optical element, of the one or more reference optical elements, is configured to return a portion of a light beam that impinges on the reference optical element. For example, the reference optical element may be configured to return, to the internal environment of the metrology system, a portion of a light beam that originates from the internal environment of the metrology system and impinges on the reference optical element. In some implementations, each reference optical element is configured to return a portion of a calibration light beam (e.g., that is emitted by the at least one light source of the metrology system) that impinges on the reference optical element.

In some implementations, each reference optical element is configured to return a portion of a calibration light beam to an optical sensor of the metrology system. The optical sensor thereby generates and provides sensor information to one or more processors of the metrology system. The one or more processors process the sensor information to determine optical path length information and optical path angle information (e.g., that are associated with one or more portions of calibration light beams returned to the optical sensor by the one or more reference optical elements). The optical path length information indicates an optical path length from the at least one light source to the one or more reference optical elements. The optical path angle information indicates an optical path angle at which the one or more portions of calibration light beams impinged on the one or more reference optical elements.

Accordingly, in some implementations, the one or more processors calibrate one or more optical components of the metrology system based on at least one of the optical path length information or the optical path angle information. In this way, the one or more processors can compensate for any unwanted effects introduced by the one or more optical components (and the window), such as due to distortions, aberrations, mechanical stress, temperature changes, ageing, or other issues. Notably, a calibration operation (e.g., that includes emitting one or more calibration light beams at the one or more reference optical elements to allow the one or more processors to obtain sensor information that can be used to calibrate the one or more optical components of the metrology system) can be done at any time, such as before or during a measurement operation (e.g., that includes emitting one or more measurement light beams emitted at a measurement target by the metrology system to allow the one or more processors to obtain sensor information that can be used to determine distances to a measurement target). This therefore increases an accuracy of any distance measurement associated with the measurement target (e.g., to regions of the measurement target), and increases an accuracy of any resulting geometry information associated with the measurement target. Further, in some implementations, the one or more processors determine a distance measurement (e.g., to a region of the measurement target) based on at least one of the optical path length information or the optical path angle information, which thereby causes the one or more processors to more accurately determine the distance measurement than would otherwise be possible based on processing only sensor information associated with a measurement light beam.

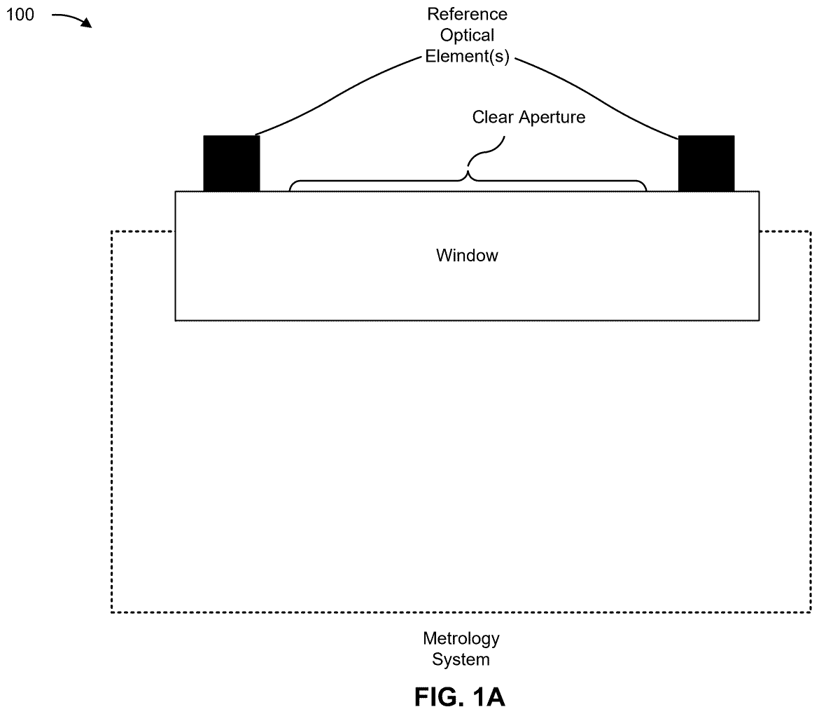

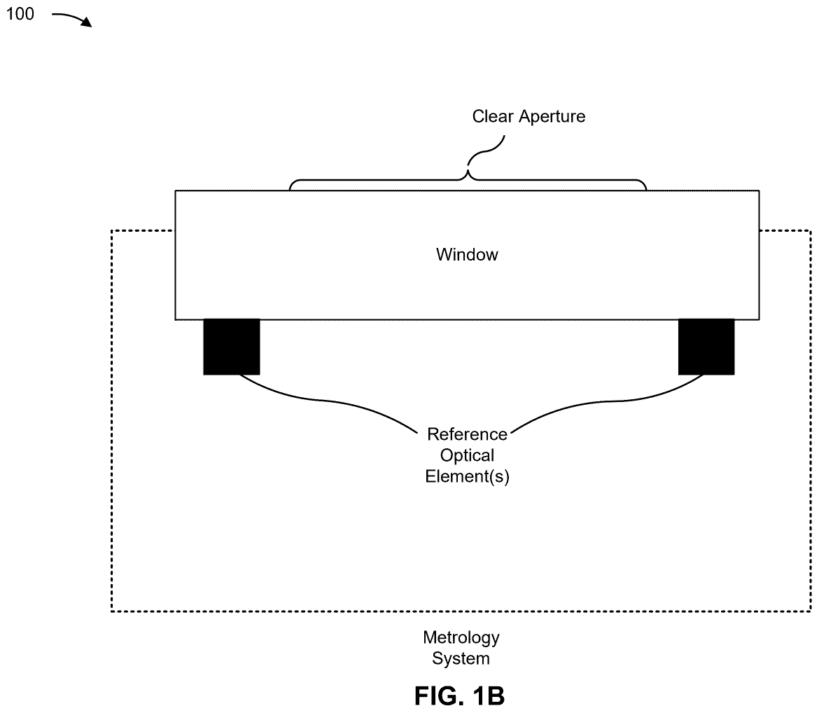

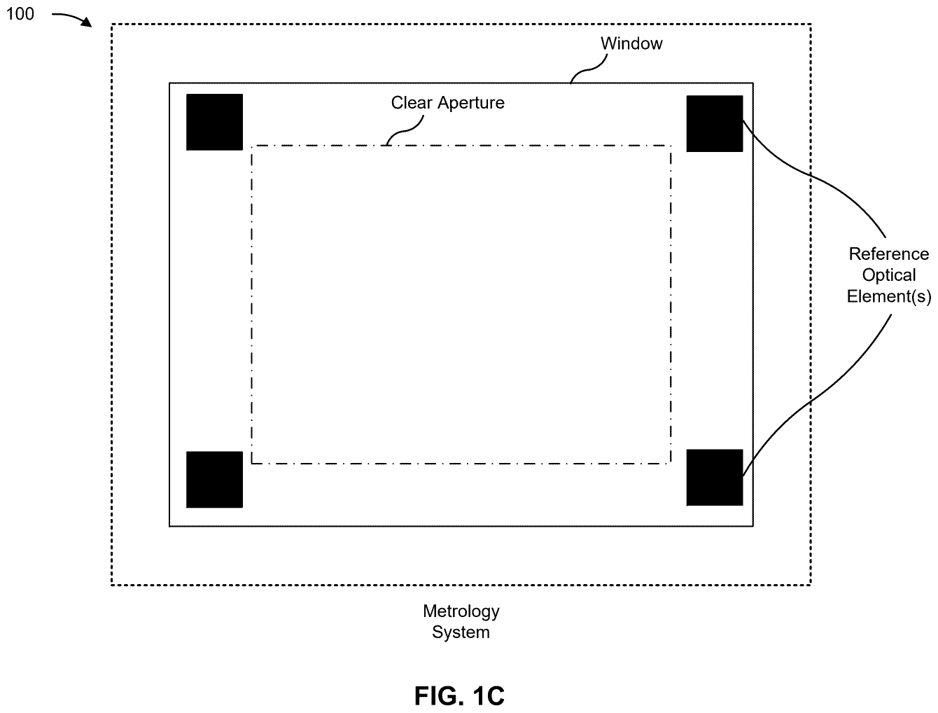

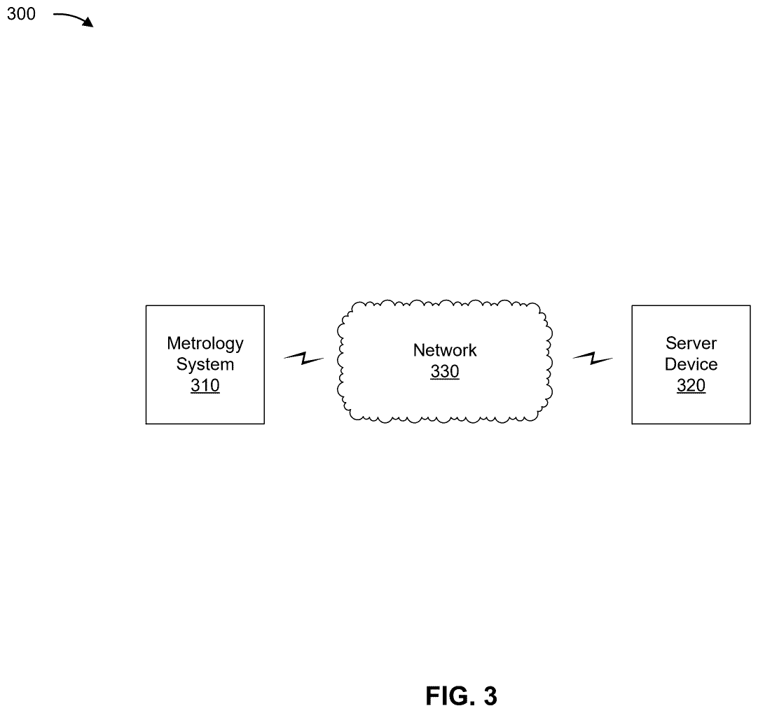

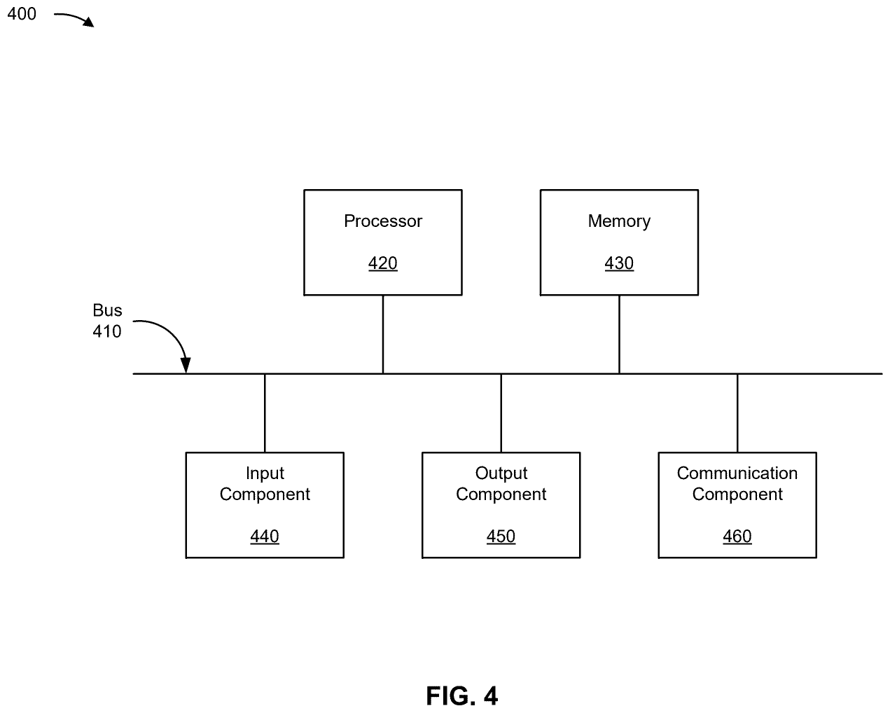

FIGS. 1A-1C are diagrams of an example implementation 100 associated with one or more reference optical elements of a metrology system. As shown in FIGS. 1A-1C, example implementation 100 includes a metrology system, which is described in more detail below in connection with FIG. 3 and FIG. 4. FIG. 1A shows a cut-away side-view of a first example configuration of the metrology system, FIG. 1B shows a cut-away side-view of a second example configuration of the metrology system, and FIG. 1C shows a top-down view of the first example configuration of the metrology system.

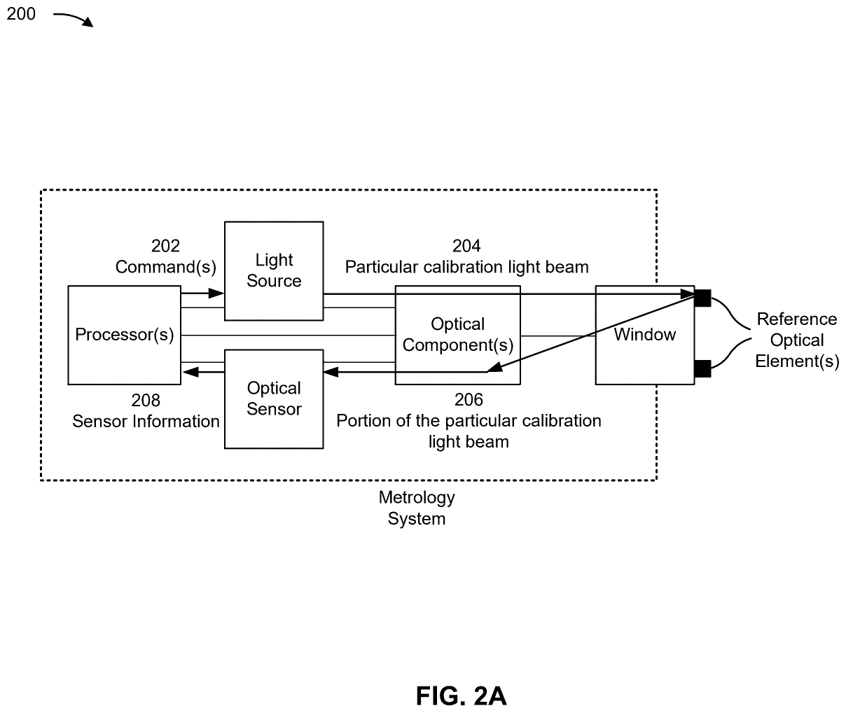

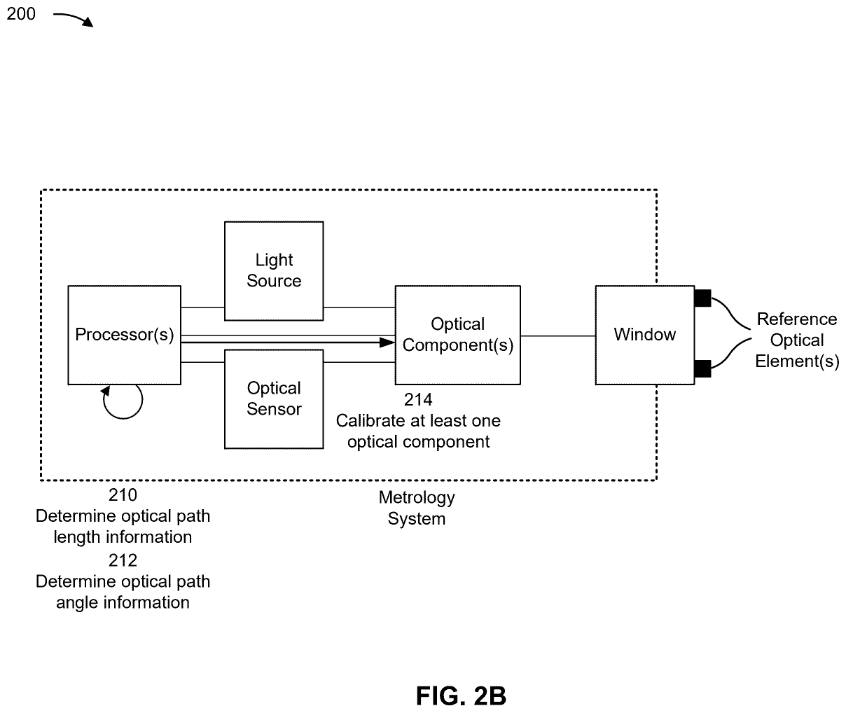

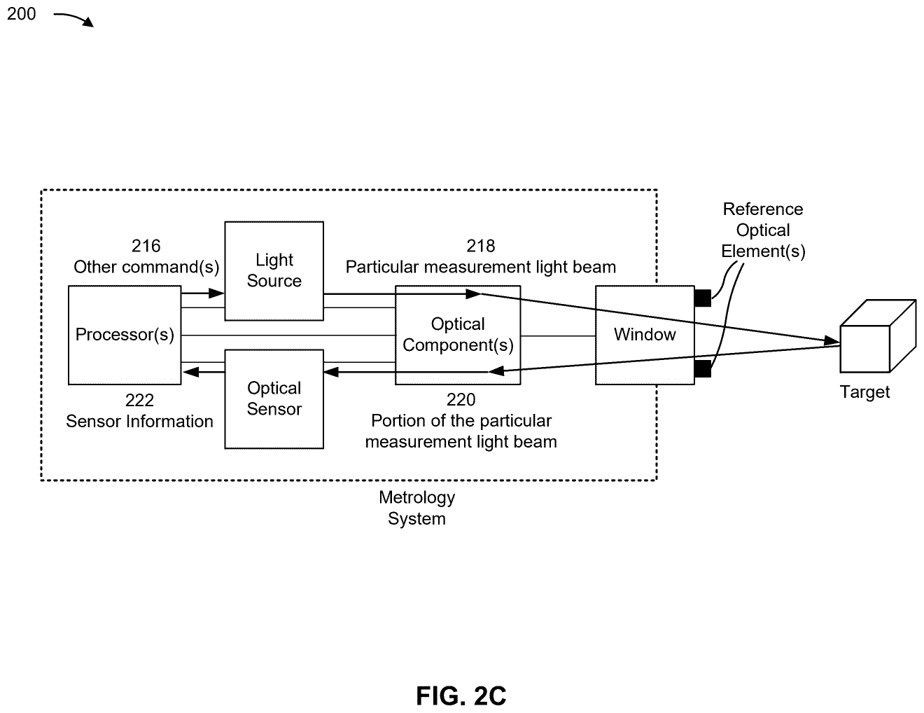

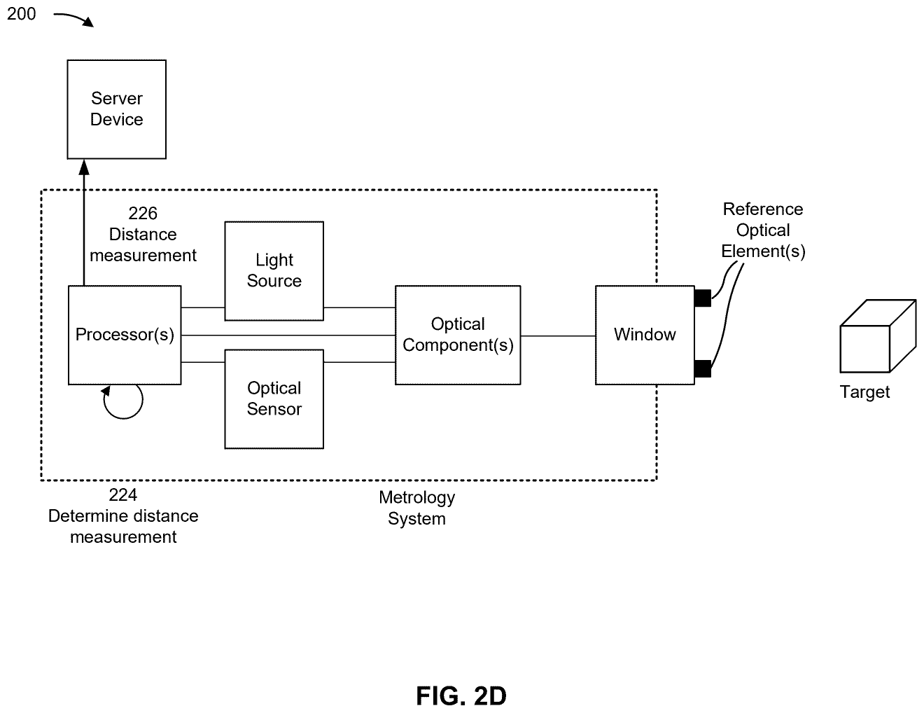

The metrology system may be configured to measure a measurement target (e.g., an object), such as shown in FIGS. 2C-2D. For example, the metrology system may be configured to measure a geometry (e.g., a three-dimensional (3D) geometry) of the measurement target.

As shown in FIGS. 1A-1C, the metrology system may include a window, which may be at an end of the metrology system. That is, the window may separate an internal environment of the metrology system from an external environment (e.g., that is not contained within the metrology system).

The window may be configured to permit transmission of a light beam. For example, the window may be configured to permit transmission of a measurement light beam (e.g., that facilitates measurement of the measurement target), such as further described herein in relation to FIG. 2C. In some implementations, the window may include a clear aperture. Accordingly, the window may be configured to permit transmission of the light beam (e.g., the measurement light beam) via the clear aperture. The window may be configured to permit transmission of the light beam (e.g., a measurement light beam) from the internal environment of the metrology system to the external environment (e.g., via the clear aperture of the window) and, in some implementations, to permit transmission of another light beam (e.g., a reflected portion of the measurement light beam, such as from the measurement target) from the external environment to the internal environment of the metrology system.

The window may comprise, for example, a glass, a polymer, or another type of transmissive material (e.g., that permits transmission of a light beam associated with a spectral range, such as transmission of a measurement light beam associated with a spectral range for measuring the measurement target). As shown in FIG. 1C, the window may have a polygonal shape (e.g., a rectangular shape), but, in some implementations, may have a round shape or another type of shape. As further shown in FIG. 1C, the clear aperture may be associated with a region of the window, such as a central region of the window. In some implementations, a first region of the window may be associated with the clear aperture, and a second region of the window may not be associated with the clear aperture. For example, as shown in FIG. 1C, the first region may be a central region and the second region may be a perimeter region (e.g., that surrounds the first region).

As shown in FIGS. 1A-1C, the metrology system may include one or more reference optical elements. The one or more reference optical elements may be disposed on the window (e.g., on a surface of the window). For example, the one or more reference optical elements may be disposed on an external surface of the window (e.g., a top surface of the window, as shown in FIGS. 1A and 1C) and/or on an internal surface of the window (e.g., a bottom surface of the window, as shown in FIG. 1B). In some implementations, the one or more reference optical elements (e.g., each reference optical element) may be disposed on a region of a surface of the window that is not associated with the clear aperture of the window (e.g., on the second region of the window). For example, as shown in FIGS. 1A-1C, the clear aperture may be associated with a central region of the window, and each reference optical element may be disposed on a perimeter region of the window. In some implementations, as shown in FIG. 1C, each reference optical element may be disposed (e.g., on the region of the surface of the window that is not associated with the clear aperture) in association with a corner, or other another geometric feature, of the window.

In some implementations, each reference optical element, of the one or more reference optical elements, may be configured to return a portion of a light beam that impinges on the reference optical element. For example, the reference optical element may be configured to return, to the internal environment of the metrology system, a portion of a light beam that originates from the internal environment of the metrology system and impinges on the reference optical element. In some implementations, each reference optical element may be configured to return a portion of a calibration light beam (e.g., as further described herein in relation to FIG. 2A) that impinges on the reference optical element. For example, each reference optical element may be configured to return a portion of a calibration light beam (e.g., that originates from the internal environment of the metrology system) that impinges on the reference optical element to another component of the metrology system (e.g., that is within the internal environment of the metrology system), such as to an optical sensor of the metrology system (e.g., as further described herein in relation to FIG. 2A).

In some implementations, each reference optical element may be at least partially transmissive. For example, the reference optical element may be configured to permit transmission of a light beam associated with a spectral range, such as transmission of a measurement light beam associated with a spectral range for measuring the measurement target.

A reference optical element, of the one or more reference optical elements, may comprise a reflective optical element (e.g., a mirror, a prism, or a similar optical element), a scattering optical element (e.g., a diffuser, or a similar optical element), and/or a diffractive optical element (e.g., a diffractive grating, a metasurface optical element, or a similar optical element). In this way, the reference optical element may be configured to return (e.g., via reflection, scattering, and/or diffraction) a light beam associated with a spectral range, such as a calibration light beam associated with a spectral range for calibrating the metrology system (e.g., as further described herein in relation to FIG. 2A). Additionally, in some implementations, the reference optical element may comprise a glass, a polymer, or another type of transmissive material (e.g., that permits transmission of a light beam associated with a spectral range, such as transmission of a measurement light beam associated with a spectral range for measuring the measurement target).

As indicated above, FIGS. 1A-1C are provided as an example. Other examples may differ from what is described with regard to FIGS. 1A-1C.

FIGS. 2A-2D are diagrams of an example implementation 200 associated with one or more reference optical elements of a metrology system. As shown in FIGS. 2A-2D, example implementation 200 includes a metrology system and a server device, which are described in more detail below in connection with FIG. 3 and FIG. 4. FIGS. 2A-2D show schematic views of the metrology system and the server device.

The metrology system may be configured to include a window and one or more reference optical elements, as described herein in relation to FIGS. 1A-1C. The metrology system may be further configured to include (e.g., within an internal environment of the metrology system) at least one light source, one or more optical components, an optical sensor, and/or one or more processors.

The at least one light source may include at least one laser light source. As further described herein, the at least one light source may be configured to emit a measurement light beam to the window (e.g., to a clear aperture of the window), such as via the one or more optical components. Further, the at least one light source may be configured to emit a calibration light beam to the window (e.g., to a reference optical element disposed on the window), such as via the one or more optical components. The measurement light beam may be associated with a first spectral range (e.g., a spectral range associated with measuring a measurement target) and the calibration light beam may be associated with a second spectral range (e.g., a spectral range associated with calibrating the metrology system). In some implementations, the first spectral range and the second spectral range may be the same (e.g., may range from a same minimum wavelength to a same maximum wavelength). Alternatively, the second spectral range may be different than the first spectral range. For example, the first spectral range and the second spectral range may not overlap, or may only partially overlap. In some implementations, the first spectral range may be associated with a non-visible spectral range (e.g., an ultraviolet spectral range and/or an infrared spectral range), and the second spectral range may be associated with a visible spectral range.

The one or more optical components may include, for example, one or more of: mirrors, lenses, beam scanners (e.g., 2D beam scanners), beamformers, optical fibers, beam splitters, beam focusers, waveplates, or other optical components. As further described herein, the one or more optical components may be configured to transmit a light beam (e.g., a measurement light beam or a calibration light beam) from the at least one light source to the window (e.g., to the clear aperture of the window for the measurement light beam, or to a reference optical element disposed on the window for the calibration light beam). Additionally, in some implementations, the one or more optical components may be configured to transmit a portion of a light beam (e.g., a portion of the measurement light beam or a portion of the calibration light beam) from the window (e.g., from the clear aperture of the window for the measurement light beam, or from the reference optical element disposed on the window for the calibration light beam) to the optical sensor.

The optical sensor may include, for example, a phase-based multi-tone continuous wave (PB-MTCW) optical sensor or an optical sensor associated with LiDAR (Light Detection and Ranging), photogrammetry, or other three-dimensional (3D) optical sensing technologies. As further described herein, the optical sensor may be configured to receive a portion of a light beam (e.g., a portion of a measurement light beam or a portion of a calibration light beam) and provide sensor information associated with the portion of the light beam, such as to the one or more processors. The one or more processors may be configured to determine, based on the sensor information, measurement information or calibration information associated with the portion of the light beam.

As shown in FIG. 2A, and by reference number 202, the one or more processors may be configured to send one or more commands. For example, the one or more processors may send the one or more commands to the at least one light source, such as via a connection (e.g., a communication connection) between the one or more processors and the at least one light source. The one or more commands may indicate that the at least one light source is to emit one or more calibration light beams (e.g., to the one or more reference optical elements, respectively).

Additionally, or alternatively, the one or more processors may send the one or more commands to the one or more optical components, such as via a connection (e.g., a communication connection) between the one or more processors and the one or more optical components. Accordingly, the one or more commands may indicate that the one or more optical components are to transmit the one or more calibration light beams (e.g., to the one or more reference optical elements, respectively), such as by adjusting one or more characteristics, settings, or other parameters of the one or more optical components. The adjustments may enable the one or more optical components to transmit the one or more calibration light beams to the one or more reference optical elements, respectively.

In some implementations, based on the one or more commands, the at least one light source may be configured to emit one or more calibration light beams, and/or the one or more optical components may be configured to transmit the one or more calibration light beams to the one or more reference optical components, respectively. For example, as shown by reference number 204, the at least one light source may be configured to emit (e.g., based on the one or more commands) a particular calibration light beam. Additionally, the one or more optical components may be configured to transmit (e.g., by making adjustments, such as based on the one or more commands) the particular calibration light beam to a particular reference optical element (e.g., shown as a top reference optical element in FIG. 2A) of the one or more reference optical elements. Accordingly, the at least one light source may be configured to emit the particular calibration light beam to the particular reference optical element via the one or more optical components.

As shown by reference number 206, the particular reference optical element may be configured to return a portion of the particular calibration light beam that impinges on the reference optical element. That is, the particular reference optical element may be configured to return, to the internal environment of the metrology system, the portion of the particular calibration light beam that originates from the internal environment (e.g., from the at least one light source and the one or more optical components) and that impinges on the particular reference optical element.

In some implementations, the particular reference optical element may be configured to return the portion of the particular calibration light beam to the optical sensor of the metrology system. For example, the one or more optical components may be configured to receive the portion of the particular calibration light beam from the particular reference optical element and to transmit the portion of the particular calibration light beam to the optical sensor. Thus, the particular reference optical element may be configured to return the portion of the particular calibration light beam to the optical sensor via the one or more optical components.

The optical sensor may be configured to receive the portion of the particular calibration light beam (e.g., from the particular reference optical element, such as via the one or more optical components). As shown by reference number 208, the optical sensor may be further configured to generate sensor information (e.g., based on the portion of the particular calibration light beam received by the optical sensor) and to send the sensor information to the one or more processors. For example, the optical sensor may send the sensor information to one or more processors via a connection (e.g., a communication connection) between the one or more processors and the optical sensor. The sensor information may indicate one or more characteristics of the portion of the particular calibration light beam, such as an intensity, phase shift, or one or more other characteristics, of the portion of the particular measurement light beam.

As shown in FIG. 2B, and by reference number 210, the one or more processors may determine (e.g., based on the sensor information received from the optical sensor) optical path length information associated with the portion of the particular calibration light beam. For example, the one or more processors may process (e.g., using one or more distance measurement techniques) the sensor information to determine an optical path length of the portion of the particular calibration light beam (e.g., from the at least one light source to the particular reference optical element).

As shown in FIG. 2B, and by reference number 212, the one or more processors may determine (e.g., based on the sensor information received from the optical sensor), optical path angle information associated with the portion of the particular calibration light beam. For example, the one or more processors may process (e.g., using one or more angle measurement techniques) the sensor information to determine an optical path angle of the portion of the particular calibration light beam (e.g., when the portion of the particular calibration light beam impinged on the particular reference optical element).

In some implementations, the at least one light source may emit (e.g., via the one or more optical components) one or more particular calibration light beams to the one or more reference optical elements, respectively. Each reference optical element may return a portion of a particular calibration light that impinges on the reference optical element to the optical sensor. The optical sensor therefore may receive, from each reference optical element (e.g., via the one or more optical components), a portion of a particular calibration light beam that is returned by the reference optical element. The optical sensor then may send, to the one or more processors, respective sensor information associated with one or more portions of particular calibration light beams received by the optical sensor.

Accordingly, the one or more processors may determine the optical path length information and/or the optical path angle information based on the respective sensor information. For example, the one or more processors may determine, based on the respective sensor information, optical path length information that indicates a representative optical path length (e.g., an average optical path length) of the one or more portions of particular calibration light beams. As another example, the one or more processors may determine, based on the respective sensor information, optical path angle information that indicates a representative optical path angle (e.g., an average optical path angle) of the one or more portions of particular calibration light beams.

As shown by reference number 214, the one or more processors may be configured to calibrate at least one optical element of the one or more optical elements. In some implementations, the one or more processors may calibrate the at least one optical component based on at least one of the optical path length information or the optical path angle information. For example, the one or more processors may cause adjustment of one or more characteristics, settings, or other parameters of the at least one optical element, such as to modify (e.g., to shorten or lengthen) an optical path length of a measurement beam from the at least one light source to the window (e.g., to the clear aperture of the window) and/or to modify an optical path angle of the measurement beam when the measurement transmits to or from the window (e.g., to or from the clear aperture of the window). In some implementations, the one or more processors may calibrate the at least one optical element by sending one or more commands to the at least one optical element, such as in a similar manner as that described elsewhere herein.

As shown in FIG. 2C, and by reference number 216, the one or more processors may be configured to send one or more other commands (e.g., after calibrating the at least one optical component, as described herein in relation to FIG. 2B and reference number 214), such as to the at least one light source. For example, the one or more processors may send the one or more other commands to the at least one light source via the connection between the one or more processors and the at least one light source. The one or more commands may indicate that the at least one light source is to emit one or more measurement light beams (e.g., to the window of the metrology system, such as to the clear aperture of the window).

Additionally, or alternatively, the one or more processors may send the one or more other commands to the one or more optical components, such as via the connection between the one or more processors and the one or more optical components. The one or more other commands may indicate that the one or more optical components are to transmit the one or more measurement light beams (e.g., to the window, such as to the clear aperture of the window), such as by adjusting one or more characteristics, settings, or other parameters of the one or more optical components. The adjustments may enable the one or more optical components to transmit the one or more measurement light beams to the window (e.g., to the clear aperture of the window).

In some implementations, based on the one or more other commands, the at least one light source may be configured to emit one or more measurement light beams and/or the one or more optical components may be configured to transmit the one or more measurement light beams to the window (e.g., to the clear aperture of the window). For example, as shown by reference number 218, the at least one light source may be configured to emit (e.g., based on the one or more other commands) a particular measurement light beam. Additionally, the one or more optical components may be configured to transmit (e.g., by making adjustments, such as based on the one or more other commands) the particular measurement light beam to the window (e.g., to the clear aperture of the window). Accordingly, the at least one light source may be configured to emit the particular measurement light beam to the window (e.g., to the clear aperture of the window) via the one or more optical components.

As further shown in FIG. 2C, the particular measurement light beam may transmit (e.g., in free space) from the window (e.g., from the clear aperture of the window) to a region of a measurement target (e.g., that is in the external environment). In some implementations, the particular measurement light beam may transmit from the window to the region of the measurement target via at least one of the one or more reference optical components (e.g., when the one or more reference optical components permit transmission of light beams associated with the first spectral range). Accordingly, as shown by reference number 220, a portion of the particular measurement light beam may return (e.g., as a reflection) from the region of the measurement target to the internal environment of the metrology system.

In some implementations, the portion of the particular measurement light beam may return to the optical sensor of the metrology system. For example, the portion of the particular measurement light beam may transmit to the window (e.g., to the clear aperture of the window), or to another window of the metrology system, and may thereby transmit to the one or more optical components. In some implementations, the portion of the particular measurement light beam may transmit to the window via at least one of the one or more reference optical components (e.g., when the one or more reference optical components permit transmission of light beams associated with the first spectral range) and then to the one or more optical components. The one or more optical components may be configured to receive the portion of the particular measurement light beam from the window, or from the other window, and to transmit the portion of the particular measurement light beam to the optical sensor. Thus, the portion of the particular measurement light beam may be returned to the optical sensor via the one or more optical components.

The optical sensor may be configured to receive the portion of the particular measurement light beam (e.g., that is returned to the internal environment of the metrology system from the region of the measurement target, such as via the one or more optical components). As shown by reference number 222, the optical sensor may be further configured to generate sensor information (e.g., based on the portion of the particular measurement light beam received by the optical sensor) and to send the sensor information to the one or more processors. For example, the optical sensor may send the sensor information to one or more processors via the connection between the one or more processors and the optical sensor. The sensor information may indicate one or more characteristics of the portion of the particular measurement light beam, such as an intensity, phase shift, or one or more other characteristics, of the portion of the particular measurement light beam.

As shown in FIG. 2D, and by reference number 224, the one or more processors may determine (e.g., based on the optical sensor receiving the portion of the particular measurement light beam, the sensor information received from the optical sensor, the optical path length information associated with the portion of the particular calibration light beam, and/or the optical path angle information associated with the portion of the particular calibration light beam) a distance measurement (e.g., from the region of the measurement target to the optical sensor). For example, the one or more processors may process (e.g., using one or more distance measurement techniques) the sensor information, the optical path length information, and/or the optical path angle information to determine the distance measurement. In this way, the one or more processors may more accurately determine the distance measurement than would otherwise be possible based on processing only sensor information associated with the particular measurement light beam.

As shown by reference number 226, the one or more processors may provide the distance measurement to another device (e.g., that is external the metrology system). For example, the metrology system may send the distance measurement to the server device, such as via a connection (e.g., a communication connection) between the one or more processors and the server device. The server device may be configured to store the distance measurement (and other distance measurements associated with the measurement target) and/or to generate and store information that indicates a geometry of the measurement target.

As indicated above, FIGS. 2A-2D are provided as an example. Other examples may differ from what is described with regard to FIGS. 2A-2D.

FIG. 3 is a diagram of an example environment 300 in which systems and/or methods described herein may be implemented. As shown in FIG. 3, environment 300 may include a metrology system 310, a server device 320, and/or a network 330. Devices of environment 300 may interconnect via wired connections, wireless connections, or a combination of wired and wireless connections.

The metrology system 310 may include one or more devices capable of receiving, generating, storing, processing, and/or providing information as described elsewhere herein. The metrology system 310 may include an optical sensor and may be configured to measure a measurement target, as described herein. The metrology system 310 may be configured to communicate with the server device 320 (e.g., via the network 330), such as to provide a distance measurement, as described herein.

The server device 320 may include one or more devices capable of receiving, generating, storing, processing, and/or providing information, as described elsewhere herein.

The server device 320 may include a communication device and/or a computing device. For example, the server device 320 may include a server, such as an application server, a client server, a web server, a database server, a host server, a proxy server, a virtual server (e.g., executing on computing hardware), or a server in a cloud computing system. In some implementations, the server device 320 may include computing hardware used in a cloud computing environment.

The network 330 may include one or more wired and/or wireless networks. For example, the network 330 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 330 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with one or more reference optical elements of a metrology system. The device 400 may correspond to the metrology system 310 and/or the server device 320. In some implementations, the metrology system 310 and/or the server device 320 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a processor or one or more processors) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A metrology system, comprising:
a window configured to permit transmission, via a clear aperture of the window, of a measurement light beam from an internal environment of the metrology system to an external environment; and
one or more reference optical elements that are disposed on the window,
wherein each reference optical element, of the one or more reference optical elements, is configured to return, to the internal environment of the metrology system, a portion of a calibration light beam that originates from the internal environment of the metrology system and impinges on the reference optical element.

2. The metrology system of claim 1, wherein each reference optical element, of the one or more reference optical elements, is disposed on a region of a surface of the window that is not associated with the clear aperture of the window.

3. The metrology system of claim 1, wherein each reference optical element, of the one or more reference optical elements, is further configured to return the portion of the calibration light beam to an optical sensor of the metrology system.

4. The metrology system of claim 1, wherein a reference optical element, of the one or more reference optical elements, includes at least one of:
a reflective optical element,
a scattering optical element, or
a diffractive optical element.

5. The metrology system of claim 1, further comprising:
one or more optical components within the internal environment of the metrology system, and
at least one light source within the internal environment of the metrology system that is configured to:
emit a particular measurement light beam to the clear aperture of the window via the one or more optical components, and
emit a particular calibration light beam to a particular reference optical element, of the one or more reference optical elements, via the one or more optical components.

6. The metrology system of claim 5, wherein the particular measurement light beam is associated with a first spectral range, and the particular calibration light beam is associated with a second spectral range that is different than the first spectral range, and
wherein each reference optical element is at least partially transmissive of light beams associated with the first spectral range.

7. The metrology system of claim 1, further comprising:
one or more optical components within the internal environment of the metrology system, and
an optical sensor within the internal environment of the metrology system that is configured to:
receive, from each reference optical element, of the one or more reference optical elements, and via the one or more optical components, a portion of a particular calibration light beam that is returned to the internal environment of the metrology system by the reference optical element.

8. The metrology system of claim 7, further comprising:
one or more processors that are configured to:
determine, based on the optical sensor receiving the portion of the particular calibration light beam, optical path length information associated with the portion of the particular calibration light beam; and
determine, based on the optical sensor receiving the portion of the particular calibration light beam, optical path angle information associated with the portion of the particular calibration light beam.

9. The metrology system of claim 8, wherein the one or more processors are further configured to:
calibrate at least one optical component, of the one or more optical components, based on at least one of the optical path length information or the optical path angle information.

10. The metrology system of claim 8, wherein:
the optical sensor is further configured to receive a portion of a particular measurement light beam that is returned to the internal environment of the metrology system from a region of a measurement target; and
the one or more processors are further configured to determine, based on the optical sensor receiving the portion of the particular measurement light beam and based on at least one of the optical path length information or the optical path angle information, a distance measurement from the region of the measurement target to the optical sensor.

11. A metrology system, comprising:
a window configured to permit transmission, via a clear aperture of the window, of a measurement light beam; and
one or more reference optical elements that are disposed on a region of a surface of the window that is not associated with the clear aperture of the window,
wherein each reference optical element, of the one or more reference optical elements, is configured to return a portion of a calibration light beam that impinges on the reference optical element.

12. The metrology system of claim 11, wherein each reference optical element, of the one or more reference optical elements, is further configured to return the portion of the calibration light beam to an optical sensor of the metrology system.

13. The metrology system of claim 11, further comprising:
one or more optical components, and
at least one light source that is configured to:
emit a particular measurement light beam to the clear aperture of the window via the one or more optical components, and
emit a particular calibration light beam to a particular reference optical element, of the one or more reference optical elements, via the one or more optical components.

14. The metrology system of claim 13, wherein the particular measurement light beam is associated with a first spectral range, and the particular calibration light beam is associated with a second spectral range that is different than the first spectral range.

15. A metrology system, comprising:
one or more reference optical elements that are disposed on a window; and
an optical sensor that is configured to:
receive, from each reference optical element, of the one or more reference optical elements, a portion of a particular calibration light beam that impinges on the reference optical element.

16. The metrology system of claim 15, wherein each reference optical element, of the one or more reference optical elements, is disposed on a region of a surface of the window that is not associated with a clear aperture of the window.

17. The metrology system of claim 15, further comprising:
one or more optical components configured to transmit the portion of the particular calibration light beam from the reference optical element from each reference optical element to the optical sensor.

18. The metrology system of claim 15, further comprising:
one or more processors that are configured to at least one of:
determine, based on the optical sensor receiving the portion of the particular calibration light beam, optical path length information associated with the portion of the particular calibration light beam; and
determine, based on the optical sensor receiving the portion of the particular calibration light beam, optical path angle information associated with the portion of the particular calibration light beam.

19. The metrology system of claim 18, wherein the one or more processors are further configured to:
calibrate at least one optical component, of the one or more optical components, based on at least one of the optical path length information or the optical path angle information.

20. The metrology system of claim 18, wherein the one or more processors are further configured to:
determine, based on the optical sensor receiving a portion of a particular measurement light beam that is returned to the metrology system from a region of a measurement target, and based on at least one of the optical path length information or the optical path angle information, a distance measurement from the region of the measurement target to the optical sensor.
